(19) United States
(12) Patent Application Publication
(10) Pub. No.: US 2012/0144408 A1
(43) Pub. Date: Jun. 7, 2012

(54) APPARATUS AND METHOD FOR DIGITAL CONTENT CREATION

(75) Inventors: Hyung Hwan KIM, Daejeon (KR); Sung Jin HUR, Daejeon (KR)

(73) Assignee: Electronics and Telecommunications Research Institute, Daejeon (KR)

(21) Appl. No.: 13/295,508

(22) Filed: Nov. 14, 2011

(30) Foreign Application Priority Data
Dec. 6, 2010 (KR) 10-2010-0123801

(51) Int. Cl. H04N 7/16; H04N 21/47

(52) U.S. Cl. 725/5; 725/60; 725/25

(57) ABSTRACT

Provided is an apparatus and method for generating digital content. The apparatus includes a physical information manager configured to manage information about a physical item distributed off-line, a video production manager configured to produce video content by generating and converting a video image of the physical item, and an interactive video production manager configured to generate digital content capable of providing an interactive service by applying a service interaction element to the video produced to be served on-line. Also, the apparatus further includes an intellectual property right manager configured to register and manage the copyright and intellectual property right related to the generated digital content and permit use of the copyright and the intellectual property right, and a unique number manager configured to issue a unique number so that the generated digital content can be identified in a distribution process.

### CLAIM FOR PRIORITY

This application claims priority to Korean Patent Application No. 10-2010-0123801 filed on Dec. 6, 2010 in the Korean Intellectual Property Office (KIPO), the entire contents of which are hereby incorporated by reference.

### BACKGROUND

1. Technical Field

Example embodiments of the present invention relate in general to an apparatus and method for generating digital content, and more particularly, to an apparatus and method for generating interactive video content providing an interactive service.

2. Related Art

Digital content can be easily duplicated, the duplication having no difference from the original. Also, digital content can be easily edited and instantly spread via the Internet. In particular, during a web-based electronic commerce transaction using digital content, special attention needs to be paid to preventing illegal distribution and duplication of the content.

To solve this problem, digital rights management (DRM), a technology for providing copyright to content and managing the copyright, has been developed and is frequently used. DRM is a product and service that employs a content protection technique and manages the profits of the copyright holder made when the protected content is used, to prevent illegal distribution and duplication of various pieces of digital content such as electronic books, music, videos, games, software, stock information, and images.

Since DRM only provides a copyright to the content itself, a method is needed to enable only a legal user to use the content and manage legal distribution and copyright to the digital content through a charging service, etc. while preventing illegal distribution and duplication of the content using DRM.

For this reason, European Strategic Program on Research in Information Technology (ESPRIT) of the European Union has proposed an Intellectual Multimedia Property Rights Model and Terminology for Universal Reference (IMPRIMATUR) business model, which is most frequently referred to in the electronic commerce industry. Also, the IMPRIMATUR model is a distribution model used as a basic concept in moving picture experts group (MPEG)-21. Subjects that prevent illegal distribution of video content and manage the copyright are provided to the IMPRIMATUR model so as to prevent unauthorized access, and express the copyright according to fields, media and periods so as to provide a reliable service.

However, such a business model merely proposes a conceptual structure and role in which flexibility and extensibility are considered, and thus a substantial implementation method is needed to implement a system using the model.

Also, existing methods are aimed at general digital content, and thus needs to be expanded so as to be applied to a business model aimed at interactive motion pictures having a function of interoperating with another service.

### SUMMARY

Accordingly, example embodiments of the present invention are provided to substantially obviate one or more problems due to limitations and disadvantages of the related art.

Example embodiments of the present invention provide an apparatus for generating digital content that provides an interactive service having a function of interoperating with another service.

Example embodiments of the present invention also provide a method of generating digital content that provides an interactive service having a function of interoperating with another service.

In some example embodiments, an apparatus for generating digital content includes: a physical information manager configured to manage information about a physical item; a video production manager configured to produce video content by generating and converting a video image of the physical item; and an interactive video production manager configured to generate digital content capable of providing an interactive service by applying a service interaction element to the video produced to be served on-line.

The apparatus may further include an intellectual property right manager configured to register and manage the copyright and intellectual property right related to the generated digital content, and permit use of the copyright and the intellectual property right.

The apparatus may further include a unique number manager configured to issue a unique number so that the generated digital content can be identified in a distribution process.

The physical information manager may include: a general information management module configured to manage basic information about the physical item; a payment information management module configured to manage payment processing information obtained from the distribution process of the physical item; a distribution information management module configured to manage distribution information that includes sales information, inventory information, and physical distribution information about the physical item, and is used and generated in the distribution process of the physical item; and an authentication information management module configured to manage authentication information about the physical item.

The video production manager may include: a content generation module configured to generate the video content about the physical item; a content editing module configured to edit the generated video content; a content storage module configured to store the video content; and a content metadata editing module configured to generate and manage metadata of the generated or processed video.

The interactive video production manager may include: an interactive video generation module configured to generate an interactive video by generating, editing and deleting an element required for interaction in the video content; an interactive video editing module configured to modify or delete the generated interactive video; an interactive video storage module configured to store the interactive video; and a metadata editing module configured to register, modify and delete metadata of the interactive video.

The intellectual property right manager may include: a copyright information management module configured to register, modify and delete copyright information about an interactive video; an intellectual property right information management module configured to register, modify and delete intellectual property right information related to the interactive video; a copyright permission module configured to manage permission related to the copyright to the interactive video; and a copyright monitoring module configured to monitor the sales volume of the interactive video and copyright related to the interactive video.

The unique number manager may include: a unique number issuing module configured to issue the unique number to digital content; and a unique number management module configured to manage the issued unique number.

In other example embodiments, a method of generating digital content performed in digital content generation apparatus includes: collecting information about a physical item in connection with an interactive video; generating and converting a video image of the physical item to produce video content; configuring an interactive element to be applied to the produced video so as to provide an interactive service on-line; and applying the configured interactive element to the video content to produce an interactive video.

The method may further include registering an intellectual property right to the produced interactive video.

The method may further include issuing a unique number for uniquely identifying the interactive video.

Issuing the unique number may be performed by a unique number issuing organization.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating the roles of action performers and the relationship between them in digital content generation process according to an example embodiment of the present invention;

FIG. 2 is a schematic block diagram of an apparatus for generating digital content according to an example embodiment of the present invention;

FIG. 3 is a block diagram of a physical information manager as a component of an apparatus for generating digital content according to an example embodiment of the present invention;

FIG. 4 is a block diagram of a video production manager as a component of an apparatus for generating digital content according to an example embodiment of the present invention;

FIG. 5 is a block diagram of an interactive video production manager as a component of an apparatus for generating digital content according to an example embodiment of the present invention;

FIG. 6 is a block diagram of an intellectual property right manager as a component of an apparatus for generating digital content according to an example embodiment of the present invention;

FIG. 7 is a block diagram of a unique number manager as a component of an apparatus for generating digital content according to an example embodiment of the present invention; and

FIG. 8 is a flowchart illustrating a process of generating digital content according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described in detail with reference to the appended drawings. To aid in understanding the present invention, like numbers refer to like elements throughout the description of the figures, and the description of the same component will not be reiterated.

An apparatus and method for generating digital content that provides an interactive service according to example embodiments of the present invention are disclosed. In particular, a model of a generation part of an interactive service distribution process is defined by the apparatus for generating digital content according to an example embodiment of the present invention. In other words, roles of respective action performers in the apparatus for generating digital content, and the resultant structure and functions are defined.

Digital content according to example embodiments of the present invention includes all types of digital information distributed in a virtual space such as digital documents, digital motion pictures, digital audio files, information obtained by digitizing analog data, and digital content processed to enable an interactive service.

An apparatus for generating digital content according to an example embodiment of the present invention may operate in action performer-specific computer hardware servers in which components perform their roles respectively in a distributed network environment, or as an individual module in one computer hardware server. Otherwise, the apparatus may operate in one module using a different program code.

An Intellectual Multimedia Property Rights Model And Terminology for Universal Reference (IMPRIMATUR) business model, which is a model according to example embodiments of the present invention, has been developed by the European Union to enable transactions of multimedia content and give rights to the same in a digital commerce transaction.

A physical item defined in example embodiments of the present invention is substance existing in an off-line environment, and denotes a management target to be treated as one unit. A physical item is an element to be converted into digital content.

Digital content defined in example embodiments of the present invention is a model defined as a digital object unit treated in the generation of digital content to the use of the digital content. Digital content may be a form of a digitized physical item, or a digitized image of a physical item obtained using a photographing apparatus.

An interactive video defined in example embodiments of the present invention denotes a video that additionally has an interactive element added thereto and thus can provide an interactive service.

Interaction defined in example embodiments of the present invention denotes an interface method provided to enable communication about digital content, which is provided to a user, between the user and a provider, or a type or form of a user response.

In connection with the apparatus and method for generating digital content according to example embodiments of the present invention, a conceptual constitution of a content generation apparatus based on an IMPRIMATUR distribution model according to an example embodiment of the present invention will be first described below, and respective components of the content generation apparatus according to an example embodiment of the present invention will be described in further detail.

### Constitution of Content Generation Apparatus Based on IMPRIMATUR Distribution Model according to Example Embodiment of Present Invention

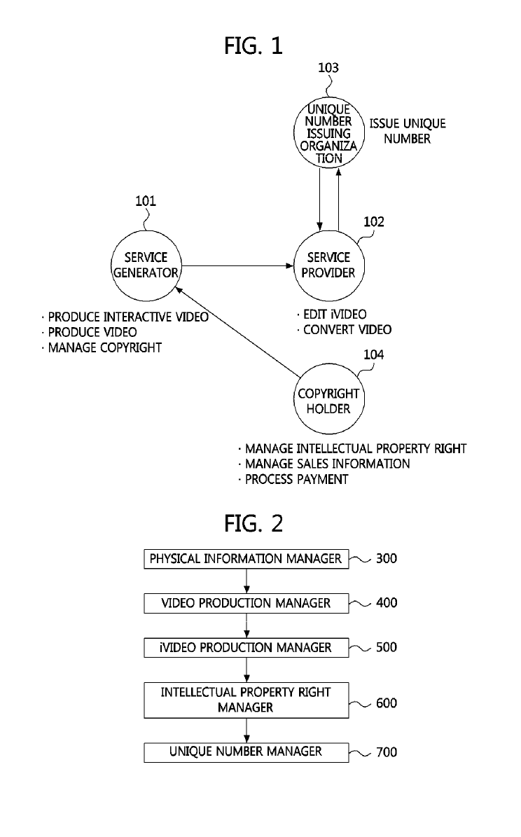

FIG. 1 is a conceptual diagram illustrating the roles of action performers and the relationship between them in digital content generation process according to an example embodiment of the present invention.

Referring to FIG. 1, the roles of action performers and the relationship between them in digital content generation process may be described as follows:

A service generator 101, a service provider 102, a unique number issuing organization 103, and a copyright holder 104 participate together in generating digital content. The generated digital content is distributed to a service intermediary, and sales information is received when a sale is made.

The service generator 101 obtains permission for a copyright from the copyright holder 104 on the basis of a video produced with regard to a physical item, and generates an interactive video. The generated interactive video is transferred to the service provider 102.

The service provider 102 requests a unique number for the digital content from the unique number issuing organization 103, and processes and registers the unique number in a digital content database. The unique number of the digital content is used to identify the digital content in a distribution process of the digital content. The unique number issuing organization 103 issues and manages the unique number of the digital content.

The copyright holder 104 provides his/her copyright to the service generator 101 and obtains profit according to sales of the digital content related to the copyright.

A constitution of digital content generation apparatus for implementing the above-described digital content generation model according to an example embodiment of the present invention will be described below.

FIG. 2 is a schematic block diagram of an apparatus for generating digital content according to an example embodiment of the present invention.

Referring to FIG. 2, an apparatus 200 for generating digital content according to an example embodiment of the present invention includes a physical information manager 300, a video production manager 400, an interactive video production manager 500, an intellectual property right manager 600, and a unique number manager 700.

Referring to FIG. 2, the respective components of the apparatus for generating digital content according to an example embodiment of the present invention may be described as follows:

The physical information manager 300 manages information about a physical item, that is, basic information related to a product actually transacted off-line.

The video production manager 400 obtains an image of the physical item and generates and manages a video item. In other words, the video production manager 400 performs a series of video item management operations of obtaining an image of the physical item through a photographing apparatus, such as a camera, and generating and converting a video item using the image.

The interactive video production manager 500 generates digital content by applying interactive information to the video item generated by the video production manager 400 to enable an interactive service, and performs management operations, such as conversion and deletion, for the generated digital content.

The intellectual property right manager 600 performs an operation of registering and managing a copyright to the generated digital content.

The unique number manager 700 generates, issues and manages a unique number so that the generated digital content can be identified when the digital content is distributed.

1) Constitution of Physical Information Manager

A constitution of the physical information manager 300 as a component of an apparatus for generating digital content according to an example embodiment of the present invention will be described in detail below.

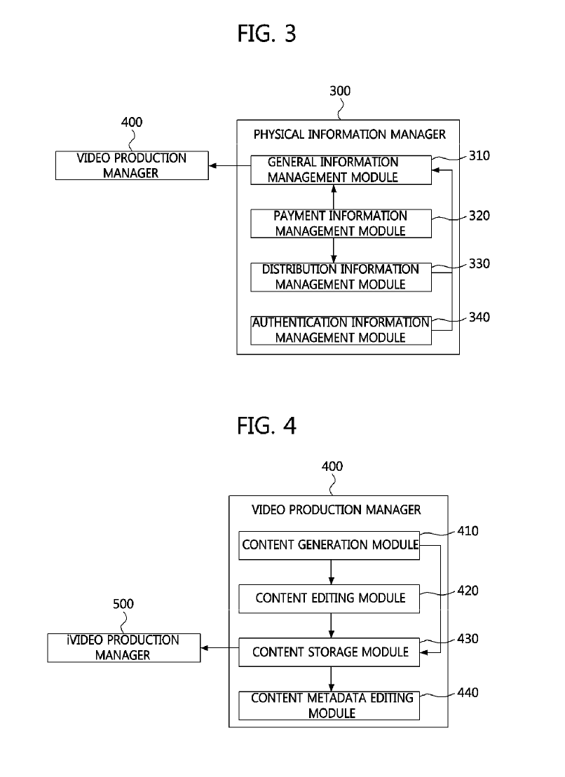

FIG. 3 is a block diagram of a physical information manager as a component of an apparatus for generating digital content according to an example embodiment of the present invention.

Referring to FIG. 3, the physical information manager 300 as a component of an apparatus for generating digital content according to an example embodiment of the present invention serves to manage information about a physical item. Here, the physical information manager 300 stores and manages information about production, distribution, authentication, etc. of the physical item, and includes a general information management module 310, a payment information management module 320, a distribution information management module 330, and an authentication information management module 340.

Referring to FIG. 3, the detailed constitution of the physical information manager 300 as a component of an apparatus for generating digital content according to an example embodiment of the present invention may be described as follows:

The general information management module 310 performs functions of generating, modifying and deleting an offline item to manage information about a physical item. In this example embodiment of the present invention, a physical item denotes an item before being converted into digital content. In other words, physical items such as products are distributed offline, and converted into digital content by a method such as photography

The payment information management module 320 performs a payment function for a physical item whose offline transaction information will be managed.

For example, the payment information management module 320 manages information about payment made by a user who has seen an interactive video and expressed his/her intention to purchase the product shown in the video. When a user who has seen an interactive video related to a cosmetic product, which is a physical item, purchases the cosmetic item, payment is carried out between the user and a service provider, or between the user and a product provider.

The distribution information management module 330 manages distribution information about the physical item.

Distribution information about products may include information about the purchase of a product, which is a physical item whose information is provided in an interactive video, made by a user.

The authentication information management module 340 manages information related to authentication and grade of the physical item.

Operation results of the respective components of the physical information manager 300 are transferred to the video production manager 400.

2) Constitution of Video Production Manager

A constitution of the video production manager 400 as a component of an apparatus for generating digital content according to an example embodiment of the present invention will be described in detail below.

FIG. 4 is a block diagram of a video production manager as a component of an apparatus for generating digital content according to an example embodiment of the present invention.

Referring to FIG. 4, the video production manager 400 as a component of an apparatus for generating digital content according to an example embodiment of the present invention obtains an image of a physical item, and generates and manages a video item. In other words, the video production manager 400 performs a series of video item management operations of obtaining an image of a physical item captured by a photographing apparatus, such as a camera, and generating or converting a video item using the image. The video production manager 400 includes a content generation module 410, a content editing module 420, a content storage module 430, and a content metadata editing module 440.

Referring to FIG. 4, the detailed constitution of the video production manager 400 as a component of an apparatus for generating digital content according to an example embodiment of the present invention may be described as follows:

As a component of the video production manager 400, the content generation module 410 performs a function of obtaining content captured as a video to generate video content about a physical item. For example, the content generation module 410 generates an image by capturing a product to go on sale.

The content editing module 420 performs an editing function of modifying or deleting the generated video content.

The content storage module 430 stores the generated video content.

The content metadata editing module 440 generates metadata of the video content. Metadata denotes basic information related to a video. In other words, the metadata may include data about what kind of items are in the video, when the video has been produced, and so on.

Operation results of the respective components of the video production manager 400 are transferred to the interactive video production manager 500.

3) Constitution of Interactive Video Production Manager

A constitution of the interactive video production manager 500 as a component of an apparatus for generating digital content according to an example embodiment of the present invention will be described in detail below.

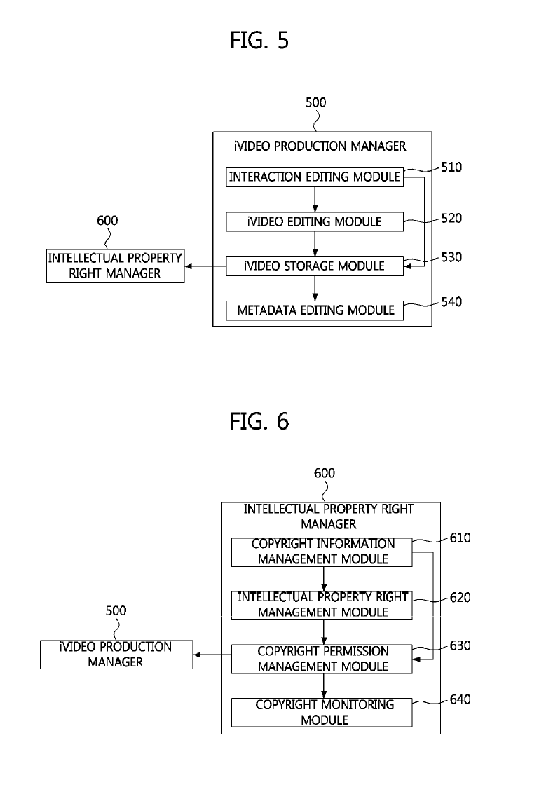

FIG. 5 is a block diagram of an interactive video production manager as a component of an apparatus for generating digital content according to an example embodiment of the present invention.

Referring to FIG. 5, the interactive video production manager 500 as a component of an apparatus for generating digital content according to an example embodiment of the present invention generates digital content to which interactive information is applied to enable an interactive service from video content generated by the video production manager 400, and performs management operations, such as modification and deletion of the generated digital content. The interactive video production manager 500 includes an interaction editing module 510, an interactive video editing module 520, an interactive video storage module 530, and a metadata editing module 540.

Referring to FIG. 5, the detailed constitution of the interactive video production manager 500 as a component of an apparatus for generating digital content according to an example embodiment of the present invention may be described as follows:

An interactive video provides a method for a receiver to directly react to the video itself other than a conventional method of unilaterally showing the video to a receiver. For example, a user may directly input his/her intention to buy a shampoo in an interactive video when he/she wants to buy the shampoo advertised in the video, or may write a product review.

The interaction editing module 510 generates an interactive video by generating, editing and deleting an element required for interaction in video content. For example, an element capable of expressing purchase intent that will be provided to a user, a product review, a means of paying for the product, etc. may be generated as the element required for interaction.

The interactive video editing module 520 edits, that is, modifies, deletes, etc., the generated interactive video.

The interactive video storage module 530 stores the interactive video.

The metadata editing module 540 performs a function of registering, modifying and deleting metadata to manage the interactive metadata.

Operation results of the respective components of the interactive video production manager 500 are transferred to the intellectual property right manager 600.

4) Constitution of Intellectual Property Right Manager

A constitution of the intellectual property right manager 600 as a component of an apparatus for generating digital content according to an example embodiment of the present invention will be described in detail below.

FIG. 6 is a block diagram of an intellectual property right manager as a component of an apparatus for generating digital content according to an example embodiment of the present invention.

Referring to FIG. 6, the intellectual property right manager 600 as a component of an apparatus for generating digital content according to an example embodiment of the present invention performs an operation of registering and managing copyrights of digital content, and includes a copyright information management module 610, an intellectual property right information management module 620, a copyright permission management module 630, and a copyright monitoring module 640.

Referring to FIG. 6, the detailed constitution of the intellectual property right manager 600 as a component of an apparatus for generating digital content according to an example embodiment of the present invention may be described as follows:

The copyright information management module 610 is requested to register, modify, and delete a copyright to an interactive video, and processes the request.

The intellectual property right information management module 620 performs a function of registering, modifying and deleting the corresponding information to manage an intellectual property right.

The copyright permission module 630 processes a request for permission to use the interactive video.

The copyright monitoring module 640 monitors the sales volume of the interactive video and copyright related to the interactive video.

5) Constitution of Unique Number Manager

A constitution of the unique number manager 700 as a component of an apparatus for generating digital content according to an example embodiment of the present invention will be described in detail below.

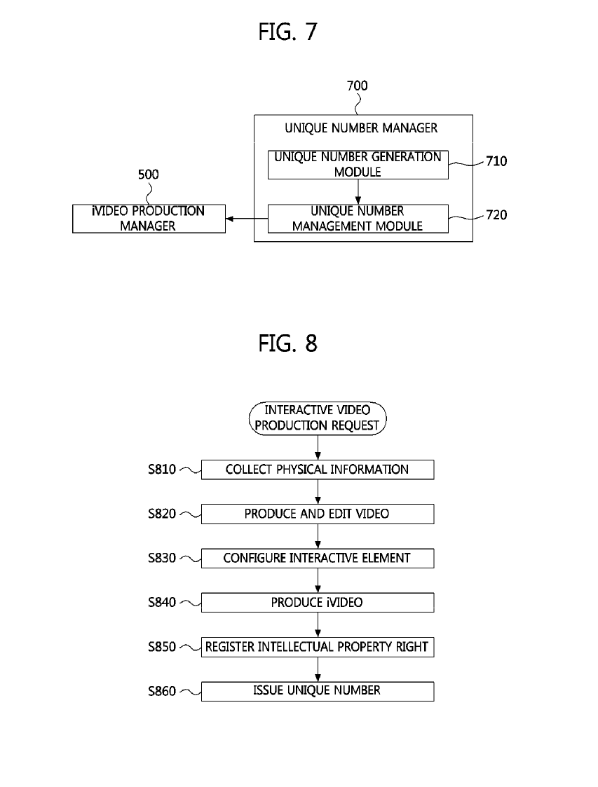

FIG. 7 is a block diagram of a unique number manager as a component of an apparatus for generating digital content according to an example embodiment of the present invention.

Referring to FIG. 7, the unique number manager 700 as a component of an apparatus for generating digital content according to an example embodiment of the present invention generates, issues and manages a unique number so that digital content can be identified when the digital content is distributed, and includes a unique number generator 710 and a unique number management module 720.

Referring to FIG. 7, the detailed constitution of the unique number manager 700 as a component of an apparatus for generating digital content according to an example embodiment of the present invention may be described as follows:

The unique number generation module 710 generates and issues a unique number to an interactive video requested to be issued with a unique number.

In other words, the unique number generation module 710 generates a unique number that enables identification of the corresponding digital content, and gives the unique number to the digital content.

The unique number management module 720 performs a management function of processing change requests, such as modification and deletion, for the issued unique number. Since unique numbers are for identifying pieces of digital content, only one identifiable unique number is given to one piece of digital content. Thus, the unique number management module 720 serves to store and manage issued unique numbers so as to prevent the same unique number from being issued.

### Description of Process of Generating Content according to Example Embodiment of Present Invention

An example of a process of generating an interactive video will be described below in connection with a digital content generation apparatus and each action performer.

FIG. 8 is a flowchart illustrating a process of generating digital content according to an example embodiment of the present invention.

Referring to FIG. 8, a process of generating digital content according to an example embodiment of the present invention may be described as follows:

When a travel agency (i.e., a copyright holder 104) develops a travel product for a summer vacation and sells the travel product through an interactive video, the travel agency requests a service generator 101 to produce an interactive video about the travel product.

At this time, the service generator 101 collects information about physical items related to the travel product (S810). For example, travel destination, hotel, scenic spots, etc. included in the travel product may be the physical items. The information is managed by a physical information manager 300.

Subsequently, videos about the physical items are produced (S820). In this case, the physical items may not correspond to the videos on a one-to-one basis. The service generator 101 generates the videos about the physical items by personally visiting and capturing the travel destination, hotel, and scenic spots, or by use of already-distributed pictures or motion picture data, and edits the videos according to distribution purpose or intention. These processes are performed by a video production manager 400.

Using the produced videos, the service generator 101 produces an interactive video to be provided to a user. At this time, an interactive element is applied to the interactive video (S830). For example, expression of intent to buy the travel product, input of a travel date, a request for detailed information, a request for estimation, etc. may be configured as the interactive element. Such an interactive element is applied to the video content to generate an interactive video (S840). These processes are performed by an interactive video production manager 500.

A copyright and an intellectual property right to the produced interactive video are registered and managed (S850). These processes are performed by an intellectual property right manager 600. According to a contract, the copyright may be managed by the service generator 101 or the copyright holder 104.

The generated interactive video is provided to a service provider 102 who provides an interactive video service to a user. The service provider 102 requests and receives a unique number for the provided interactive video from a unique issuing organization 103 (S860). The given unique number is used to identify the interactive video in a distribution process of the interactive video. This process is performed by a unique number manager 700.

Example embodiments of the present invention provide an apparatus and method for generating interactive digital content that can be applied to a business model for an interactive motion picture having a function of interoperating with another service. The apparatus and method can be combined with a variety of services utilizing an interactive digital service, and particularly used with ease in motion picture education, electronic commerce, etc.

According to example embodiments of the present invention, an advertiser can personally generate or modify an advertising message using an advertisement generator, and thus it is possible to provide accurate advertising service in real time.

While the example embodiments of the present invention and their advantages have been described in detail, it should be understood that various changes, substitutions and alterations may be made herein without departing from the scope of the invention.

What is claimed is:

1. An apparatus for generating digital content, comprising:
a physical information manager configured to manage information about a physical item;
a video production manager configured to produce video content by generating and converting a video image of the physical item; and
an interactive video production manager configured to generate digital content capable of providing an interactive service by applying a service interaction element to the video produced to be served on-line.

2. The apparatus of claim 1, further comprising an intellectual property right manager configured to register and manage copyright and intellectual property right related to the generated digital content, and permit use of the copyright and the intellectual property right.

3. The apparatus of claim 1, further comprising a unique number manager configured to issue a unique number so that the generated digital content can be identified in a distribution process.

4. The apparatus of claim 1, wherein the physical information manager includes:
a general information management module configured to manage basic information about the physical item;
a payment information management module configured to manage payment processing information obtained from a distribution process of the physical item;
a distribution information management module configured to manage distribution information that includes sales information, inventory information, and physical distribution information about the physical item, and is used and generated in the distribution process of the physical item; and
an authentication information management module configured to manage authentication information about the physical item.

5. The apparatus of claim 1, wherein the video production manager includes:
a content generation module configured to generate video content about the physical item;
a content editing module configured to edit the generated video content;
a content storage module configured to store the video content; and
a content metadata editing module configured to generate and manage metadata of the generated or processed video.

6. The apparatus of claim 1, wherein the interactive video production manager includes:
an interactive video generation module configured to generate an interactive video by generating, editing and deleting an element required for interaction in the video content;
an interactive video editing module configured to modify or delete the generated interactive video;
an interactive video storage module configured to store the interactive video; and
a metadata editing module configured to register, modify and delete metadata of the interactive video.

7. The apparatus of claim 2, wherein the intellectual property right manager includes:
a copyright information management module configured to register, modify and delete copyright information about an interactive video;
an intellectual property right information management module configured to register, modify and delete intellectual property right information related to the interactive video;
a copyright permission module configured to manage permission related to copyright to the interactive video; and
a copyright monitoring module configured to monitor a sales volume of the interactive video and copyright related to the interactive video.

8. The apparatus of claim 3, wherein the unique number manager includes:
a unique number issuing module configured to issue the unique number to the digital content; and
a unique number management module configured to manage the issued unique number.

9. A method of generating digital content performed in digital content generation apparatus, the method comprising:
collecting information about a physical item in connection with an interactive video;
generating and converting a video image of the physical item to produce video content;
configuring an interactive element to be applied to the produced video to provide an interactive service on-line; and
applying the configured interactive element to the video content to produce an interactive video.

10. The method of claim 9, further comprising registering an intellectual property right to the produced interactive video.

11. The method of claim 9, further comprising issuing a unique number for uniquely identifying the interactive video.

12. The method of claim 11, wherein issuing the unique number is performed by a unique number issuing organization.
